(19) United States
(12) Patent Application Publication
(10) Pub. No.: US 2025/0284728 A1
(43) Pub. Date: Sep. 11, 2025

(54) CONTEXT LARGE LANGUAGE MODEL OUTPUT EXPLANATION

(71) Applicant: International Business Machines Corporation, Armonk, NY (US)

(72) Inventors: Lucas W. Monteiro Paes, Cambridge, MA (US); Dennis Wei, Sunnyvale, CA (US); Ronny Luss, Glen Rock, NJ (US); Amit Dhurandhar, YORKTOWN HEIGHTS, NY (US); Karthikeyan Natesan Ramamurthy, Pleasantville, NY (US); Soumya Ghosh, Boston, MA (US); Manish Nagireddy, Cambridge, MA (US); Inkit Padhi, White Plains, NY (US); Prasanna Sattigeri, Acton, MA (US)

(73) Assignee: International Business Machines Corporation, Armonk, NY (US)

(21) Appl. No.: 18/595,630

(22) Filed: Mar. 5, 2024

(51) Int. Cl. G06F 16/383; G06F 40/284

(52) U.S. Cl. CPC G06F 16/383; G06F 40/284

(57) ABSTRACT

An embodiment causes a target large language model (LLM) to generate, from a first input to the target LLM, a first output. The embodiment perturbs a portion of the first input. The embodiment causes the target LLM to generate a first perturbed output from the perturbed input. The embodiment scalarizes the first perturbed output. The embodiment aggregates, into an importance score corresponding to the portion, the scalar and a set of additional scalars representing differences between the first output and an additional perturbed output generated by the target LLM from an additional perturbation of the portion. The embodiment explains, responsive to determining that the importance score is the highest importance score in a set of importance scores, the first output using the portion. The embodiment trains, using the portion and the importance score, an importance scoring model.

### BACKGROUND

The present invention relates generally to large language models (LLMs). More particularly, the present invention relates to a method, system, and computer program for in-context large language model output explanation.

An LLM is a language model that implements general-purpose language generation and understanding, by taking an input text and repeatedly predicting the next token or word. An LLM is able to perform tasks such as answering a question on a corpus of text, summarizing a corpus of text, and classifying a corpus of text. LLMs are typically implemented using artificial neural networks, for example using a transformer-based architecture or a recurrent neural network-based architecture. LLMs are typically trained using a computationally intensive self-supervised and semi-supervised training process.

### SUMMARY

The illustrative embodiments provide for in-context large language model output explanation. An embodiment includes causing a target large language model (LLM) to generate, from a first input to the target LLM, a first output, the first input comprising natural language text input to the target LLM, the first output comprising natural language text output from the target LLM. The embodiment includes perturbing a portion of the first input, the perturbing resulting in a perturbed input, wherein a size of the portion is controlled by a perturbation size parameter. The embodiment includes causing the target LLM to generate a first perturbed output from the perturbed input. The embodiment includes scalarizing the first perturbed output, the scalarizing generating a scalar representing a difference between the first output and the first perturbed output. The embodiment includes aggregating, into an importance score corresponding to the portion, the scalar and a set of additional scalars, each additional scalar in the set of additional scalars representing a difference between the first output and an additional perturbed output, the additional perturbed output generated by the target LLM from an additional perturbation of the portion. The embodiment includes explaining, responsive to determining that the importance score is the highest importance score in a set of importance scores, the first output using the portion. The embodiment includes training, using the portion and the importance score, an importance scoring model, the importance scoring model comprising an artificial neural network. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for in-context large language model output explanation in accordance with an illustrative embodiment;

FIG. 3 depicts an example of in-context large language model output explanation in accordance with an illustrative embodiment;

FIG. 4 depicts a continued example of in-context large language model output explanation in accordance with an illustrative embodiment;

FIG. 5 depicts an example of aggregation used in in-context large language model output explanation in accordance with an illustrative embodiment;

FIG. 6 depicts another example of aggregation used in in-context large language model output explanation in accordance with an illustrative embodiment;

FIG. 7 depicts an example of multi-level in-context large language model output explanation in accordance with an illustrative embodiment;

FIG. 8 depicts an example of training a model to perform in-context large language model output explanation in accordance with an illustrative embodiment; and

FIG. 9 depicts a flowchart of an example process for in-context large language model output explanation in accordance with an illustrative embodiment.

### DETAILED DESCRIPTION

The illustrative embodiments recognize that, due to an LLM's complex architecture, an LLM produces output, but not necessarily an explanation of that output. A model's outputs can vary, even using the same prompt (i.e., an input to an LLM). As well, a commercially available LLM is typically a black box, with little or no information available about the model's internal architecture or weights used in layers of the neural network implementing the LLM. However, LLM users want an explanation of an LLM's particular output. Without an explanation of an LLM's output, it is difficult for a user to evaluate a model's accuracy and consistency, and to validate the model's conclusions. LLMs also have (possibly long) text as input and output, making the model verification task more difficult for a human user. LLMs are also more opaque and are more likely to produce unexpected behavior than conventional machine learning models. For example, in context-grounded/retrieval-augmented question answering, users would like to know whether the LLM actually relied on the provided document(s), and which documents and which parts of documents were more important in producing the LLM response, to help a user determine whether the LLM is attending appropriately to the documents and whether the prompt should be modified. In addition, in some jurisdictions an explanation of a model's decision must be provided to a user affected by the decision.

Chain of thought, one method of LLM output explanation, relies on prompting a model to explain its reasoning, However, chain of thought requires that the LLM be trained to provide an explanation, and the explanation is not guaranteed to conform to the model's actual behavior. Other presently available techniques augment or compare LLM output with results from another source, identify factual statements within LLM output for human fact-checking, or require access to the LLM internals such as model weights or gradients. Thus, the illustrative embodiments recognize that there is an unmet need to generate LLM explanations that score an importance of parts of the input in generating the output, using a method that does not require knowledge of a model's internals or special model training, and that is faithful to the model's actual behavior.

The present disclosure addresses the deficiencies described above by providing a process (as well as a system, method, machine-readable medium, etc.) that causes a target LLM) to generate a first output from a first input; perturbs a portion of the first input; causes the target LLM to generate a first perturbed output from the perturbed input; generates a scalar representing a difference between the first output and the first perturbed output; aggregates the scalar and a set of additional scalars into an importance score corresponding to the portion; explains the first output using the portion; and uses the portion and the importance score to train an importance scoring model. Thus, the illustrative embodiments provide for in-context large language model output explanation.

An illustrative embodiment receives a first input to a target LLM (i.e., a first prompt), and causes the target LLM to generate an output from the first input. An embodiment's task is to explain the target LLM's generated output. Both the input and the target LLM's output include natural language text. For example, one prompt might include a context, such as a text document, and a question on a portion of the context or a request to summarize the context.

An embodiment perturbs a portion of the first input, resulting in a perturbed input. An embodiment controls a size of the portion using a perturbation size parameter. Some non-limiting examples of perturbation size parameter settings are a value denoting a word, a value denoting a sentence, a value denoting a paragraph, and values denoting multiple words, sentences, and paragraphs. For example, if the perturbation size parameter is set to a value denoting a word, an embodiment selects a sentence (or another multi-word grouping within the first input, and generates perturbations of the selected sentence, by replacing one or more words (or tokens converted from words) of the selected sentence with a mask token. A mask token is an indicator to an LLM of a missing word that the LLM should fill in. As another example, if the perturbation size parameter is set to a value denoting a sentence, an embodiment selects a paragraph (or another multi-sentence grouping) within the first input, and generates perturbations of the selected paragraph, by replacing one or more sentences of the selected paragraph with a mask token. As another example, if the perturbation size parameter is set to a value denoting a paragraph, an embodiment selects a group of paragraphs within the first input, and generates perturbations of the selected paragraphs, by replacing one or more paragraphs of the selected group of paragraphs with a mask token. Words, sentences, and paragraphs are used herein only as examples of English-language textual units, and other portion sizes, appropriate to English or another language, are also possible and contemplated within the scope of the illustrative embodiments.

Another embodiment generates perturbations by replacing one or more words, sentences, paragraphs, or other textual units from a portion with another token, such as a token indicating an empty space. Another embodiment generates perturbations by removing one or more words, sentences, paragraphs, or other textual units from a portion. Another embodiment generates perturbations by replacing one or more words, sentences, paragraphs, or other textual units from a portion with a mask token, then using a replacement LLM to generate a replacement portion by replacing the mask token with a word, sentence, paragraph, or other textual unit. A replacement LLM is an LLM trained or prompted to replace a textual unit with another textual unit. For example, a replacement LLM might replace “There [MASK] a shortage of capital” with “There is a shortage of capital”. The replacement LLM need not be the same as the target LLM. As well, a replacement LLM is often language-specific. For example, one replacement LLM might be adapted to text in English while another might be adapted to text in French. Other perturbation techniques are also possible and contemplated within the scope of the illustrative embodiments.

An embodiment prompts the target LLM with one or more perturbed inputs causing the target LLM to generate a perturbed output corresponding to each perturbed input. An embodiment uses a presently available technique to scalarize a perturbed output. Scalarizing generates a scalar representing a difference between the target LLM's original output (i.e., the output an embodiment is to explain) and a perturbed output. In mathematical terms, given an original input x a target LLM produces an output y=M(x), and given a perturbed input x′ a target LLM produces an output y′=M(x′). S(y′, y) denotes the scalarizing function computing a difference between y and y′. An embodiment selects a scalarizing technique according to the type of output produced by the target LLM and the access an embodiment has to internal data of the target LLM. For example, if the target LLM outputs a classification, and thus y is a predicted label, and an embodiment has access to logits of the target LLM, an embodiment might compute S(y′, y) as a predicted logit for label y when the target LLM is given input x′. As another example, if the target LLM output y is a phrase or other sequence of a few tokens or words, and an embodiment has access to probability data within the target LLM an embodiment might compute S(y′, y) as a probability of the target LLM generating y conditioned on input x′. As another example, if the target LLM output y is a sentence or other sequence longer than a phrase, and an embodiment does not have access to internal data of the target LLM, an embodiment might compute S(y′, y) as a similarity between y and y′ using a presently available semantic similarity measure such as the natural language inference (NLI) entailment score, BERTScore, (a similarity score taking context into account), by computing a similarity between embeddings (i.e., a multidimensional numerical representation generated by a trained embedding model) representing each output being compared, or using another metric. Other scalarizing techniques are also possible and contemplated within the scope of the illustrative embodiments.

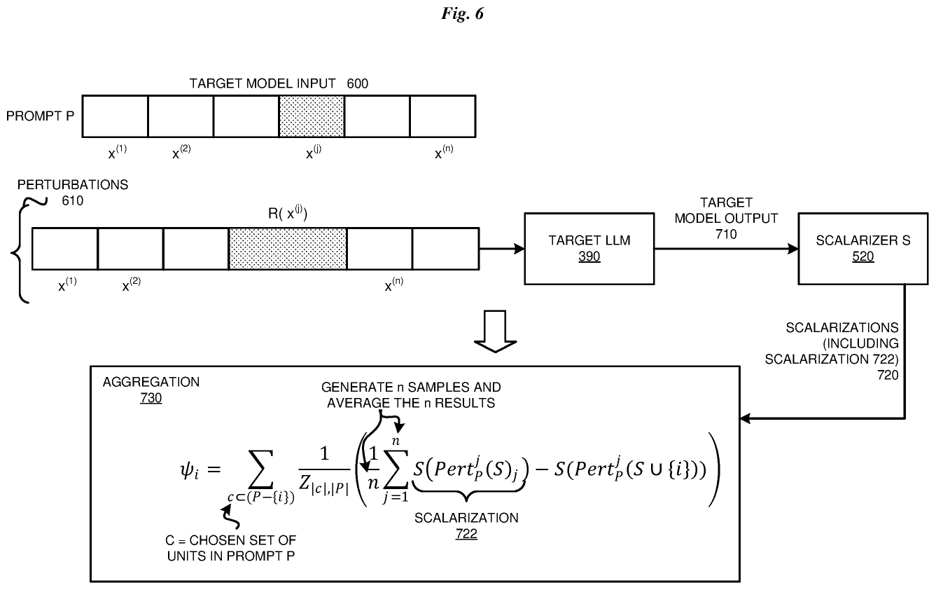

An embodiment aggregates one or more of the scalars into an importance score corresponding to the perturbed portion. An importance score corresponding to the perturbed portion is a measure of the original (i.e., before perturbation) portion's importance in explaining the original output. To perform the aggregation, one embodiment fits a local linear model representing how much each replaced unit j, in a perturbed input, has changed a corresponding perturbed output. In particular, in the model, if D(R(x^{(j)}), x^{(j)}) denotes a distance between original prompt x and perturbed prompt x′ (with prompt portion x^{(j)} replaced by R(x^{(j)}), scalarization S(y′, y) is approximately equal to a first constant (denoted by β₀) plus the sum of Bⱼ multiplied by D(R(x^{(j)}), x^{(j)} for all the prompt portions j. Note that x^{(j)} refers to the j^{th} prompt portion. To fit the linear model, one embodiment uses a presently available linear regression technique in which the targets (i.e., the dependent variables) for the linear regression are given by the scalars, and the features (i.e., independent variables) represent the distance, i.e., how much each prompt portion has been perturbed. To aggregate scalarizations, another embodiment performs aggregation 730 in FIG. 6, calculating the weighted average of the change in scalarization when a prompt portion is perturbed, compared to when the prompt portion is kept unchanged, thus quantifying the impact of each unit on an overall outcome through a weighted average of scalarization differences. Other aggregation techniques are also presently available and contemplated within the scope of the illustrative embodiments.

Because an importance score corresponding to a perturbed portion is a measure of the original (i.e., before perturbation) portion's importance in explaining the target LLM's original output, an embodiment uses a portion's importance score to explain the target LLM's original output. In particular, an embodiment uses the portion with the highest importance score to explain the target LLM's original output. For example, an embodiment might display the portion with the highest importance score, in context, along with the target LLM's output to show how well the target LLM has responded to the prompt. If the portion and the target LLM's output are sufficiently similar, to a human user evaluating an embodiment's explanation, the human user is likely to consider the target LLM as having performed the prompted task correctly. On the other hand, if the portion and the target LLM's output are not sufficiently similar, to a human user evaluating an embodiment's explanation, the human user is likely to consider the target LLM as not having performed the prompted task correctly, for example by generating output unsupported by a given context or existing facts. As well, multiple portions with similar importance scores, that are all lower than a threshold value, can indicate that the target LLM was confused by the original prompt, and thus the target LLM's answer should not be accepted and the prompt should be revised to try to produce a better output.

To reduce the number of model inferences required to identify a portion with which to explain the target LLM's original output, an embodiment uses a multi-level procedure. In particular, an embodiment performs the perturbation, scalarization, and aggregation with a perturbation size parameter set to a value denoting a largest unit, for example a paragraph, to identify an important portion with a size corresponding to the largest unit (e.g., a paragraph-size portion). Then an embodiment performs the perturbation, scalarization, and aggregation with a perturbation size parameter set to a value denoting a smaller unit than the starting unit, for example a sentence, to identify an important medium-size (e.g., sentence-size) portion within the already-identified largest-size portion. Then an embodiment performs the perturbation, scalarization, and aggregation with a perturbation size parameter set to a value denoting an even smaller unit, for example a word, to identify an important smallest-size (e.g., word-size or phrase-size) within the already-identified medium-size portion. Note that if the largest size unit is larger than a paragraph, for example a document page, section, or chapter, additional perturbation size parameter values, denoting additional portion sizes for perturbation, are also possible and contemplated within the scope of the illustrative embodiments. Other portion sizes, and other quantifies of portion size parameter settings, are also possible and contemplated within the scope of the illustrative embodiments.

To further reduce the number of model inferences required to identify a portion with which to explain the target LLM's original output, an embodiment uses portions and their corresponding importance scores as training data to train an importance scoring model to assign importance scores to portions of new prompts. The importance scoring model comprises an artificial neural network, such as a recurrent neural network (RNN), and an embodiment performs the training using a presently available model training technique.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

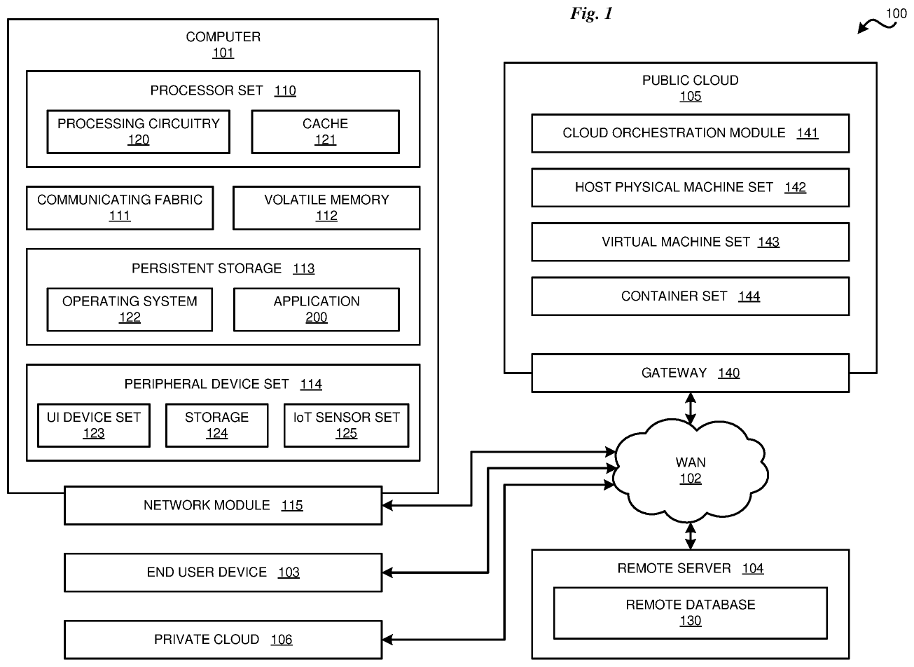

With reference to FIG. 1, this figure depicts a block diagram of a computing environment 100. Computing environment 100 contains an example of an environment for the execution of at least some of the computer code involved in performing the inventive methods, such as block 200 implementing in-context large language model output explanation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

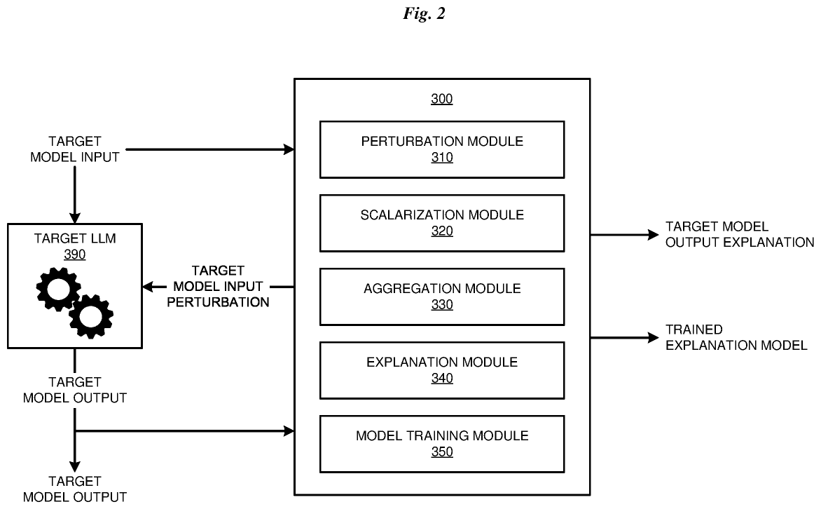

With reference to FIG. 2, this figure depicts a block diagram of an example configuration for in-context large language model output explanation in accordance with an illustrative embodiment. Application 300 is the same as application 200 in FIG. 1.

In the illustrated embodiment, application 300 receives a first input to target LLM 390 (i.e., a first prompt), and causes target LLM 390 to generate an output from the first input. Application 300's task is to explain target LLM 390's generated output. Both the input and the target LLM 390's output include natural language text. For example, one prompt might include a context, such as a text document, and a question on a portion of the context or a request to summarize the context.

Perturbation module 310 perturbs a portion of the first input, resulting in a perturbed input. Module 310 controls a size of the portion using a perturbation size parameter. Some non-limiting examples of perturbation size parameter settings are a value denoting a word, a value denoting a sentence, a value denoting a paragraph and values denoting multiple words, sentences, and paragraphs. For example, if the perturbation size parameter is set to a value denoting a word, module 310 selects a sentence (or another multi-word grouping within the first input, and generates perturbations of the selected sentence, by replacing one or more words (or tokens converted from words) of the selected sentence with a mask token. A mask token is an indicator to an LLM of a missing word that the LLM should fill in. As another example, if the perturbation size parameter is set to a value denoting a sentence, module 310 selects a paragraph (or another multi-sentence grouping) within the first input, and generates perturbations of the selected paragraph, by replacing one or more sentences of the selected paragraph with a mask token. As another example, if the perturbation size parameter is set to a value denoting a paragraph, module 310 selects a group of paragraphs within the first input, and generates perturbations of the selected paragraphs, by replacing one or more paragraphs of the selected group of paragraphs with a mask token. Words, sentences, and paragraphs are used herein only as examples of English-language textual units, and other portion sizes, appropriate to English or another language, are also possible.

Another implementation of module 310 generates perturbations by replacing one or more words, sentences, paragraphs, or other textual units from a portion with another token, such as a token indicating an empty space. Another implementation of module 310 generates perturbations by removing one or more words, sentences, paragraphs, or other textual units from a portion. Another implementation of module 310 generates perturbations by replacing one or more words, sentences, paragraphs, or other textual units from a portion with a mask token, then using a replacement LLM to generate a replacement portion by replacing the mask token with a word, sentence, paragraph, or other textual unit. A replacement LLM is an LLM trained or prompted to replace a textual unit with another textual unit. For example, a replacement LLM might replace “There [MASK] a shortage of capital” with “There is a shortage of capital”. The replacement LLM need not be the same as the target LLM. As well, a replacement LLM is often language-specific. For example, one replacement LLM might be adapted to text in English while another might be adapted to text in French. Other perturbation techniques are also possible and contemplated within the scope of the illustrative embodiments.

Module 310 prompts the target LLM with one or more perturbed inputs causing target LLM 390 to generate a perturbed output corresponding to each perturbed input. Scalarization module 320 uses a presently available technique to scalarize a perturbed output. Scalarizing generates a scalar representing a difference between target LLM 390's original output (i.e., the output an embodiment is to explain) and a perturbed output. In mathematical terms, given an original input x target LLM 390 produces an output y=M(x), and given a perturbed input x′ a target LLM produces an output y′=M(x′). S(y′, y) denotes the scalarizing function computing a difference between y and y′. Module 320 selects a scalarizing technique according to the type of output produced by the target LLM and the access an embodiment has to internal data of the target LLM. For example, if the target LLM outputs a classification, and thus y is a predicted label, and module 320 has access to logits of the target LLM, module 320 might compute S(y′, y) as a predicted logit for label y when the target LLM is given input x′. As another example, if the target LLM output y is a phrase or other sequence of a few tokens or words, and module 320 has access to probability data within the target LLM, module 320 might compute S(y′, y) as a probability of the target LLM generating y conditioned on input x′. As another example, if the target LLM output y is a sentence or other sequence longer than a phrase, and module 320 does not have access to internal data of the target LLM, module 320 might compute S(y′, y) as a similarity between y and y′ using a presently available semantic similarity measure such as the natural language inference (NLI) entailment score, BERTScore, (a similarity score taking context into account), by computing a similarity between embeddings (i.e., a multidimensional numerical representation generated by a trained embedding model) representing each output being compared, or using another metric. Other scalarizing techniques are also possible.

Aggregation module 330 aggregates one or more of the scalars into an importance score corresponding to the perturbed portion. An importance score corresponding to the perturbed portion is a measure of the original (i.e., before perturbation) portion's importance in explaining the original output. To perform the aggregation, one implementation of module 330 fits a local linear model representing how much each replaced unit j, in a perturbed input, has changed a corresponding perturbed output. In particular, in the model, if D(R(x^{(j)}), x^{(j)}) denotes a distance between original prompt x and perturbed prompt x′ (with prompt portion x^{(j)} replaced by R(x^{(j)}), scalarization S(y′, y) is approximately equal to a first constant (denoted by α₀) plus the sum of Bⱼ multiplied by D(R(x^{(j)}), x^{(j)}) for all the prompt portions j. Note that x^{(j)} refers to the j^{th} prompt portion. To fit the linear model, one implementation of module 330 uses a presently available linear regression technique in which the targets (i.e., the dependent variables) for the linear regression are given by the scalars, and the features (i.e., independent variables) represent the distance, i.e., how much each prompt portion has been perturbed. To aggregate scalarizations, another implementation of module 330 performs aggregation 730 in FIG. 6, calculating the weighted average of the change in scalarization when a prompt is perturbed, compared to when the prompt portion is kept unchanged, thus quantifying the impact of each unit on an overall outcome through a weighted average of scalarization differences. Other aggregation techniques are also presently available.

Because an importance score corresponding to a perturbed portion is a measure of the original (i.e., before perturbation) portion's importance in explaining the target LLM's original output, explanation module 340 uses a portion's importance score to explain the target LLM's original output. In particular, module 340 uses the portion with the highest importance score to explain target LLM 390's original output. For example, module 340 might display the portion with the highest importance score, in context, along with target LLM 390's output to show how well target LLM 390 has responded to the prompt. If the portion and target LLM 390's output are sufficiently similar, to a human user evaluating an embodiment's explanation, the human user is likely to consider target LLM 390 as having performed the prompted task correctly. On the other hand, if the portion and target LLM 390's output are not sufficiently similar, to a human user evaluating an embodiment's explanation, the human user is likely to consider target LLM 390 as not having performed the prompted task correctly, for example by generating output unsupported by a given context or existing facts. As well, multiple portions with similar importance scores, that are all lower than a threshold value, can indicate that target LLM 390 was confused by the original prompt, and thus target LLM 390's answer should not be accepted and the prompt should be revised to try to produce a better output.

To reduce the number of model inferences required to identify a portion with which to explain the target LLM's original output, one implementation of application 300 uses a multi-level procedure. In particular, application 300 performs the perturbation, scalarization, and aggregation with a perturbation size parameter set to a value denoting a largest unit, for example a paragraph, to identify an important portion with a size corresponding to the largest unit (e.g., a paragraph-size portion). Then application 300 performs the perturbation, scalarization, and aggregation with a perturbation size parameter set to a value denoting a smaller unit than the starting unit, for example a sentence, to identify an important medium-size (e.g., sentence-size) portion within the already-identified largest-size portion. Then application 300 performs the perturbation, scalarization, and aggregation with a perturbation size parameter set to a value denoting an even smaller unit, for example a word, to identify an important smallest-size (e.g., word-size or phrase-size) within the already-identified medium-size portion. Note that if the largest size unit is larger than a paragraph, for example a document page, section, or chapter, additional perturbation size parameter values, denoting additional portion sizes for perturbation, are also possible. Other portion sizes, and other quantifies of portion size parameter settings, are also possible.

To further reduce the number of model inferences required to identify a portion with which to explain the target LLM's original output, model training module 350 uses portions and their corresponding importance scores as training data to train an importance scoring model to assign importance scores to portions of new prompts. The importance scoring model comprises an artificial neural network, such as a recurrent neural network (RNN), and module 350 performs the training using a presently available model training technique.

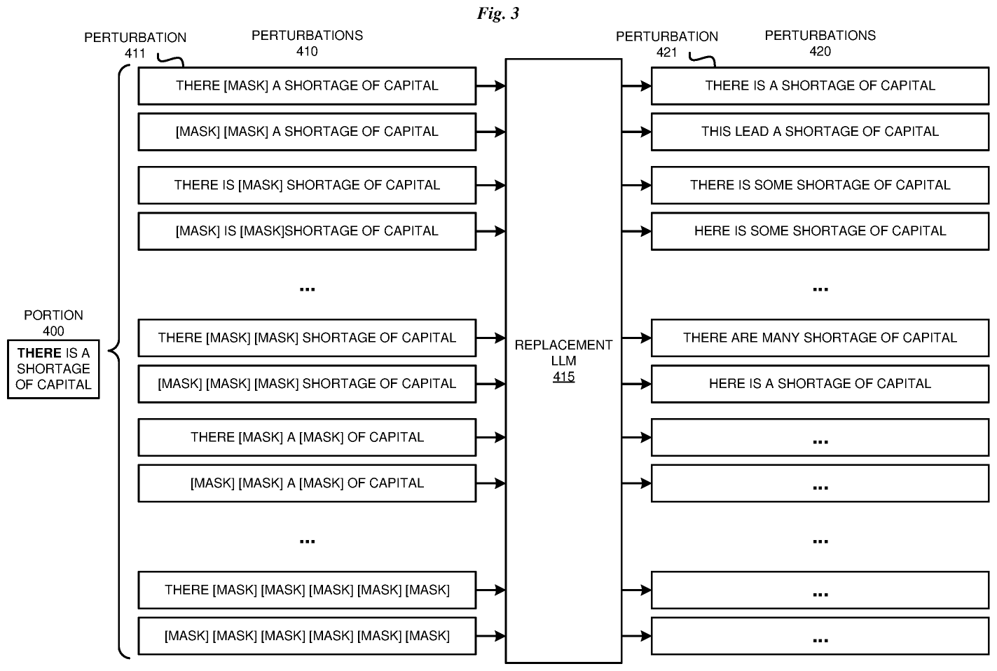

With reference to FIG. 3, this figure depicts an example of in-context large language model output explanation in accordance with an illustrative embodiment. The example can be executed using application 300 in FIG. 2.

In particular, portion 400 is a portion of a first input to a target LLM such as target LLM 390 in FIG. 3. Perturbations 410, including perturbation 411, are example perturbations of portion 400, using a perturbation size parameter setting with a value denoting a word. Thus, in perturbations 410 various words within portion 400 have been replaced by a mask token. Further, replacement LLM 415 has been used to generate perturbations 420, including perturbation 421 by replacing the mask token in perturbations 410 with a word.

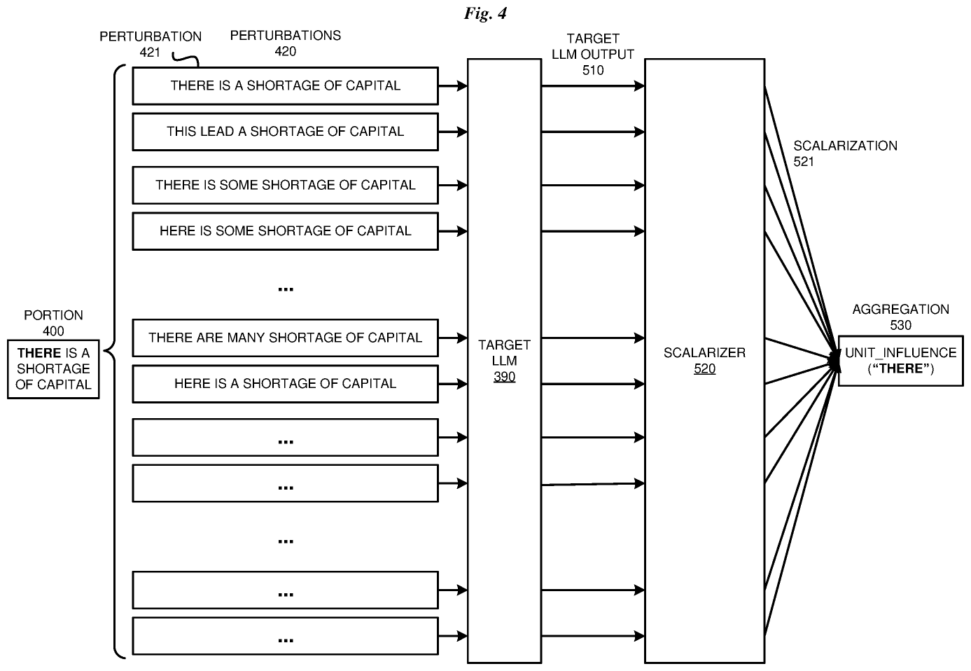

With reference to FIG. 4, this figure depicts a continued example of in-context large language model output explanation in accordance with an illustrative embodiment. Target LLM 390 is the same as target LLM 390 in FIG. 2. Portion 400, perturbations 420, and perturbation 421 are the same as portion 400, perturbations 420, and perturbation 421 in FIG. 3.

Perturbation 421 is an input to target LLM 390, which generates target LLM output 510. Other perturbations in perturbations 420 are also input to target LLM 390, which generates corresponding outputs. Scalarizer 520 scalarizes target LLM output 510, producing scalarization 521. Aggregation 530 aggregates scalarization 521 and additional scalarizations of target LLM outputs, producing an importance score for the word “There” in portion 400.

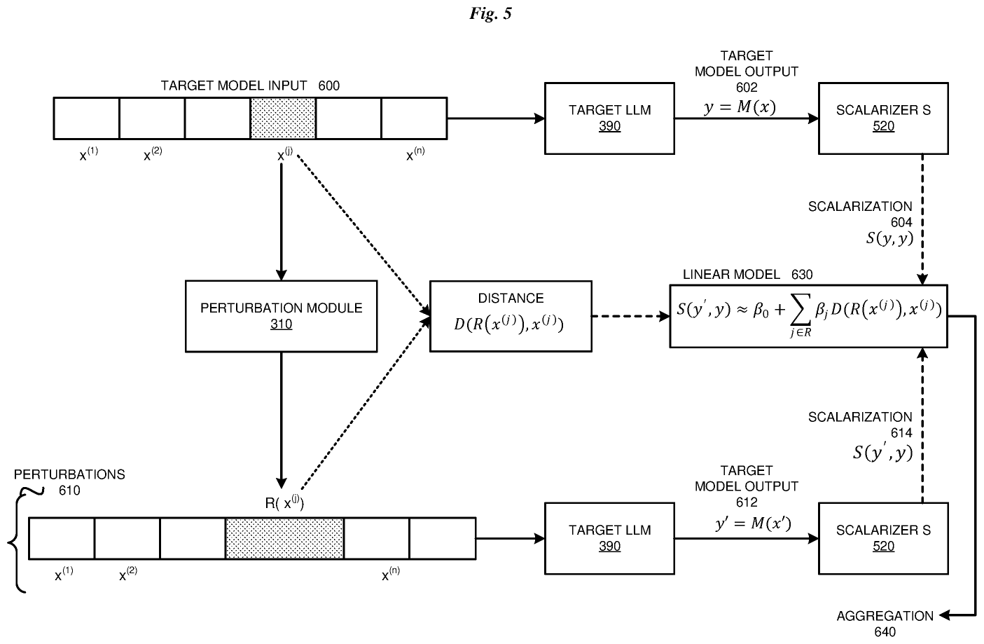

With reference to FIG. 5, this figure depicts an example of aggregation used in in-context large language model output explanation in accordance with an illustrative embodiment. Perturbation module 310 and target LLM 390 are the same as perturbation module 310 and target LLM 390 in FIG. 2. Scalarizer 520 is the same as scalarizer 520 in FIG. 4.

Perturbation module 310 replaces unit j in target model input 600 (original prompt x) with R(xⱼ) in perturbations 610 (perturbed prompt x′). D(R(x^{(j)}), x^{(j)}) denotes a distance between original prompt x and perturbed prompt x′. Target LLM 390 produces target model output 602 (an output y=M(x)) from original prompt x, and produces target model output 612 (an output y′=M(x′)) from perturbed input x′. Scalarizer 520 produces scalarization 604 (S(y, y)) from target model output 602 and produces scalarization 614 (S(y′, y)) from target model output 612. To perform aggregation 640 aggregating scalarization 614 with additional scalarizations, application 300 fits linear model 630 representing how much each replaced unit j, in a perturbed input, has changed a corresponding perturbed output. In particular, in model 630, if D(R(x^{(j)}, x^{(j)}) denotes a distance between original prompt x and perturbed prompt x′ (with element x^{j} replaced by R(x^{j}), scalarization S(y′, y) is approximately equal to a first constant (denoted by β₀) plus the sum of Bⱼ multiplied by D(R(x^{(j)}), x^{(j)}) for all the elements j.

With reference to FIG. 6, this figure depicts another example of aggregation used in in-context large language model output explanation in accordance with an illustrative embodiment. Target LLM 390 is the same as target LLM 390 in FIG. 2. Scalarizer 520 is the same as scalarizer 520 in FIG. 4. Target model input 600 and perturbations 610 are the same as target model input 600 and perturbations 610 in FIG. 5.

Target LLM 390 produces target model output(s) 710 from perturbations 610, and scalarizer 520 produces scalarizations 720 including scalarization 722. To aggregate scalarizations 720, application 300 performs aggregation 730, calculating the weighted average of the change in scalarization when one prompt is perturbed, compared to when the prompt is kept unchanged, thus quantifying the impact of each unit on an overall outcome through a weighted average of scalarization differences.

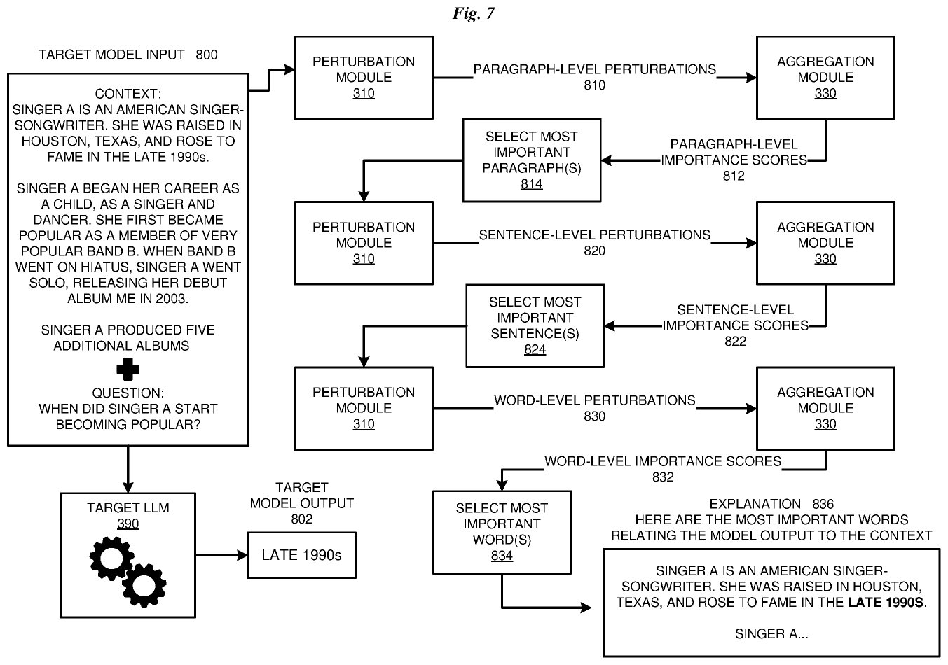

With reference to FIG. 7, this figure depicts an example of multi-level in-context large language model output explanation in accordance with an illustrative embodiment. Perturbation module 310, aggregation module 330, and target LLM 390 are the same as perturbation module 310, aggregation module 330, and target LLM 390 in FIG. 2.

As depicted, target model input 800 is applied to target LLM 390, generating target model output 802, a model output to be explained. Perturbation module 310 uses a perturbation size parameter set to a value denoting a paragraph to generate paragraph-level perturbations 810. After processing by target LLM 390 and scalarization, aggregation module 330 generates corresponding paragraph-level importance scores 812. In block 814, application 300 selects the most important paragraph(s). Perturbation module 310 uses a perturbation size parameter set to a value denoting a sentence to generate sentence-level perturbations 820 of the most important paragraph(s). After processing by target LLM 390 and scalarization, aggregation module 330 generates corresponding sentence-level importance scores 822. In block 824, application 300 selects the most important sentence(s). Perturbation module 310 uses a perturbation size parameter set to a value denoting a word to generate word-level perturbations 830 of the most important sentence(s). After processing by target LLM 390 and scalarization, aggregation module 330 generates corresponding word-level importance scores 832. In block 834, application 300 selects the most important word(s) and uses them to generate explanation 836.

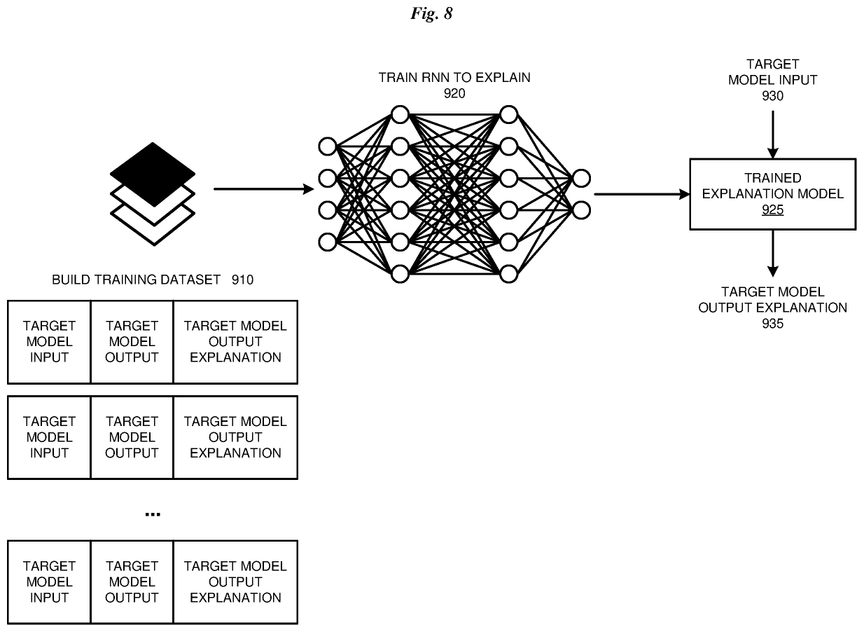

With reference to FIG. 8, this figure depicts an example of training a model to perform in-context large language model output explanation in accordance with an illustrative embodiment. The example can be executed using application 300 in FIG. 2.

As depicted, in step 910 application 300 builds a training dataset using portions and their corresponding importance scores, and in step 920 application 300 uses the training dataset to train an importance scoring model, for example an RNN, to assign importance scores to portions of new prompts. The result is trained explanation model 925, which is used to generate target model output explanation 935 from target model input 930.

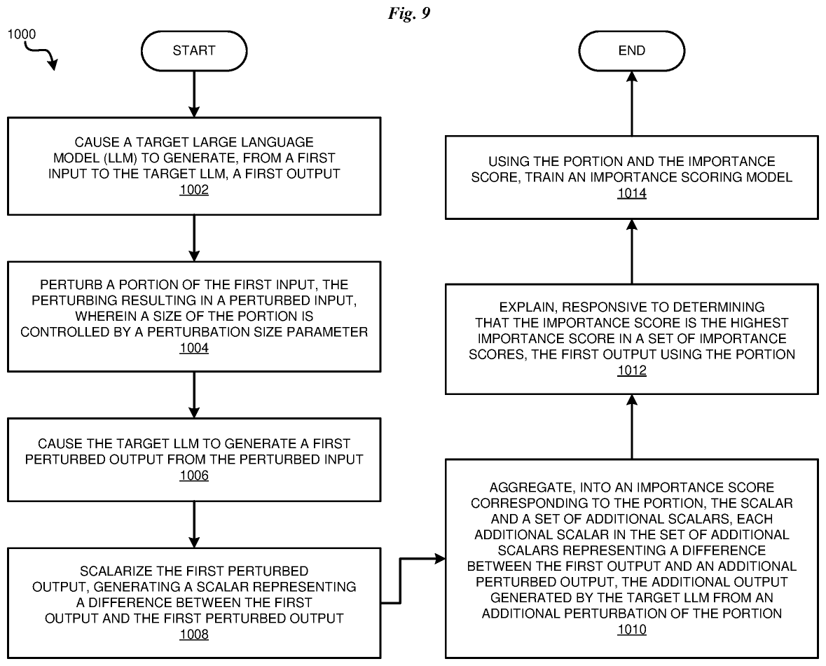

With reference to FIG. 9, this figure depicts a flowchart of an example process for in-context large language model output explanation in accordance with an illustrative embodiment. Process 1000 can be implemented in application 300 in FIG. 2.

In the illustrated embodiment, at block 1002, the process causes a target large language model (LLM) to generate, from a first input to the target LLM, a first output. At block 1004, the process perturbs a portion of the first input, the perturbing resulting in a perturbed input, wherein a size of the portion is controlled by a perturbation size parameter. At block 1006, the process causes the target LLM to generate a first perturbed output from the perturbed input. At block 1008, the process scalarizes the first perturbed output, generating a scalar representing a difference between the first output and the first perturbed output. At block 1010, the process aggregates, into an importance score corresponding to the portion, the scalar and a set of additional scalars, each additional scalar in the set of additional scalars representing a difference between the first output and an additional perturbed output, the additional output generated by the target LLM from an additional perturbation of the portion. At block 1012, the process explains, responsive to determining that the importance score is the highest importance score in a set of importance scores, the first output using the portion. At block 1014, the process, using the portion and the importance score, trains an importance scoring model. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
causing a target large language model (LLM) to generate, from a first input to the target LLM, a first output, the first input comprising natural language text input to the target LLM, the first output comprising natural language text output from the target LLM;
perturbing a portion of the first input, the perturbing resulting in a perturbed input, wherein a size of the portion is controlled by a perturbation size parameter;
causing the target LLM to generate a first perturbed output from the perturbed input;
scalarizing the first perturbed output, the scalarizing generating a scalar representing a difference between the first output and the first perturbed output;
aggregating, into an importance score corresponding to the portion, the scalar and a set of additional scalars, each additional scalar in the set of additional scalars representing a difference between the first output and an additional perturbed output, the additional perturbed output generated by the target LLM from an additional perturbation of the portion;
explaining, responsive to determining that the importance score is the highest importance score in a set of importance scores, the first output using the portion; and
training, using the portion and the importance score, an importance scoring model, the importance scoring model comprising an artificial neural network.

2. The computer-implemented method of claim 1, wherein perturbing the portion of the first input comprises removing the portion from the first input.

3. The computer-implemented method of claim 1, wherein perturbing the portion of the first input comprises replacing the portion with a mask token.

4. The computer-implemented method of claim 1, wherein perturbing the portion of the first input comprises replacing the portion with a replacement portion, the replacement portion generated by a replacement LLM.

5. The computer-implemented method of claim 1, wherein aggregating, into the importance score corresponding to the portion, the scalar and the set of additional scalars comprises estimating, using a value of the perturbation size parameter, a linear relationship between members of a set comprising the scalar and the set of additional scalars.

6. The computer-implemented method of claim 1, wherein aggregating, into the importance score corresponding to the portion, the scalar and the set of additional scalars comprises computing a weighted average of differences between members of a set comprising the scalar and the set of additional scalars.

7. A computer program product comprising one or more computer readable storage media, and program instructions collectively stored on the one or more computer readable storage media, the program instructions executable by a processor to cause the processor to perform operations comprising:
causing a target large language model (LLM) to generate, from a first input to the target LLM, a first output, the first input comprising natural language text input to the target LLM, the first output comprising natural language text output from the target LLM;
perturbing a portion of the first input, the perturbing resulting in a perturbed input, wherein a size of the portion is controlled by a perturbation size parameter;
causing the target LLM to generate a first perturbed output from the perturbed input;
scalarizing the first perturbed output, the scalarizing generating a scalar representing a difference between the first output and the first perturbed output;
aggregating, into an importance score corresponding to the portion, the scalar and a set of additional scalars, each additional scalar in the set of additional scalars representing a difference between the first output and an additional perturbed output, the additional perturbed output generated by the target LLM from an additional perturbation of the portion;
explaining, responsive to determining that the importance score is the highest importance score in a set of importance scores, the first output using the portion; and
training, using the portion and the importance score, an importance scoring model, the importance scoring model comprising an artificial neural network.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein perturbing the portion of the first input comprises removing the portion from the first input.

11. The computer program product of claim 7, wherein perturbing the portion of the first input comprises replacing the portion with a mask token.

12. The computer program product of claim 7, wherein perturbing the portion of the first input comprises replacing the portion with a replacement portion, the replacement portion generated by a replacement LLM.

13. The computer program product of claim 7, wherein aggregating, into the importance score corresponding to the portion, the scalar and the set of additional scalars comprises estimating, using a value of the perturbation size parameter, a linear relationship between members of a set comprising the scalar and the set of additional scalars.

14. The computer program product of claim 7, wherein aggregating, into the importance score corresponding to the portion, the scalar and the set of additional scalars comprises computing a weighted average of differences between members of a set comprising the scalar and the set of additional scalars.

15. A computer system comprising a processor and one or more computer readable storage media, and program instructions collectively stored on the one or more computer readable storage media, the program instructions executable by the processor to cause the processor to perform operations comprising:
causing a target large language model (LLM) to generate, from a first input to the target LLM, a first output, the first input comprising natural language text input to the target LLM, the first output comprising natural language text output from the target LLM;
perturbing a portion of the first input, the perturbing resulting in a perturbed input, wherein a size of the portion is controlled by a perturbation size parameter;
causing the target LLM to generate a first perturbed output from the perturbed input;
scalarizing the first perturbed output, the scalarizing generating a scalar representing a difference between the first output and the first perturbed output;
aggregating, into an importance score corresponding to the portion, the scalar and a set of additional scalars, each additional scalar in the set of additional scalars representing a difference between the first output and an additional perturbed output, the additional perturbed output generated by the target LLM from an additional perturbation of the portion;
explaining, responsive to determining that the importance score is the highest importance score in a set of importance scores, the first output using the portion; and
training, using the portion and the importance score, an importance scoring model, the importance scoring model comprising an artificial neural network.

16. The computer system of claim 15, wherein perturbing the portion of the first input comprises removing the portion from the first input.

17. The computer system of claim 15, wherein perturbing the portion of the first input comprises replacing the portion with a mask token.

18. The computer system of claim 15, wherein perturbing the portion of the first input comprises replacing the portion with a replacement portion, the replacement portion generated by a replacement LLM.

19. The computer system of claim 15, wherein aggregating, into the importance score corresponding to the portion, the scalar and the set of additional scalars comprises estimating, using a value of the perturbation size parameter, a linear relationship between members of a set comprising the scalar and the set of additional scalars.

20. The computer system of claim 15, wherein aggregating, into the importance score corresponding to the portion, the scalar and the set of additional scalars comprises computing a weighted average of differences between members of a set comprising the scalar and the set of additional scalars.
